(19) United States
(12) Patent Application Publication
(10) Pub. No.: US 2003/0231660 A1
(43) Pub. Date: Dec. 18, 2003

(54) Bit-manipulation instructions for packet processing

(76) Inventors: Bapiraju Vinnakota, Fremont, CA (US); Saleem Mohammadali, Fremont, CA (US); Carl Alberola, Fremont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/172,196

(22) Filed: Jun. 14, 2002

(51) Int. Cl. H04J 3/00

(52) U.S. Cl. 370/474; 370/476

(57) ABSTRACT

Embodiments of the invention relate to bit manipulation instructions that perform efficient bit manipulation operations for packet processing applications. In one embodiment, a bit manipulation instruction for use in packet processing includes a control. In response to the control, the bit manipulation instruction selects a plurality of bits from a source register and writes the selected plurality of bits into a destination register in a manner designated by the control. In an exemplary environment, the bit manipulation instruction may be implemented by a packet processor core of packet processor in a network device. In particular, five bit manipulation instructions for bit extraction, bit packing, bit setting, bit unpacking, and bit matching operations will be disclosed. These instructions are particularly useful for packet processing applications.

### BACKGROUND

1. Field of the Invention

Embodiments of the invention relate to the field of instruction sets. More particularly, embodiments of the invention relate to bit-manipulation instructions for packet processing.

2. Description of Related Art

Microprocessors have instruction sets called microcode that programmers use to create low-level computer programs. The instruction sets perform various tasks, such as moving values into registers or executing instructions to add the values in registers. Microcode can be either simple or complex, depending on the microprocessor manufacturer's preference and the intended use of the chip.

Traditional Reduced Instruction Set Computer (RISC) designs, as the name implies, have a reduced set of instructions that improve the efficiency of the processor, but also require more complex external programming. Particularly, traditional RISC based computer architecture reduces programming complexity by using simpler instructions and a reduced set of instructions. In traditional RISC architectures, the microcode layer and associated overhead is eliminated. Moreover, traditional RISC architectures keep instruction size constant, ban indirect addressing modes and retain only those instructions that can be overlapped and made to execute in one machine cycle or less.

By using traditional RISC designs that include simple instructions and control flow, hardware size can be minimized and clock speed can be increased. When designing an instruction set for a specific application, a traditional RISC instruction set can be augmented by instructions that accelerate the functionality needed for the particular application. These instructions can be particularly tailored to improve performance by reducing the number of cycles needed for operations commonly used in the target application, while attempting to preserve the clock speed.

For example, packet processing for voice applications generally requires the manipulation of several layers of protocol headers and several types of protocols and oftentimes traditional RISC based instruction set processors are utilized to perform these tasks. However, packet processing requires the ability to manipulate bits efficiently, especially in complex protocols such as Asynchronous Transfer Mode (ATM) and ATM adaption layers (AALs). Unfortunately, traditional RISC instructions only operate on bytes or words of data (e.g. two or four bytes of data). Thus, while bit manipulation is possible using traditional RISC instructions, a large number of machine cycles are required even for implementing simple operations. Therefore, utilizing traditional RISC instructions for bit manipulations in packet processing results in serious inefficiencies.

### BRIEF DESCRIPTION OF THE DRAWINGS

FIG. 1 shows an illustrative example of a voice and data communications system.

FIG. 2 is a simplified block diagram illustrating a conventional multi-service access device in which embodiments of the present invention can be practiced.

FIG. 3 is a simplified block diagram illustrating an example of a packet processing card in which embodiments of the present invention can be practiced.

FIG. 4 is a simplified block diagram illustrating an example of a packet processor in which embodiments of the present invention can be practiced.

FIG. 5 illustrates a process for implementing an instruction according to one embodiment of the present invention.

FIG. 6 shows a plurality of source operand registers and destination operand registers, which may be utilized in implementing embodiments of the present invention.

FIG. 7 provides a table of the instructions and a short description of each instruction, according to embodiments of the invention.

FIG. 8 illustrates an EXTR (i.e. extraction) instruction according to one embodiment of the invention.

FIG. 9 illustrates a PACK (i.e. packing) instruction according to one embodiment of the invention.

FIG. 10 illustrates a SET (i.e. setting) instruction according to one embodiment of the invention.

FIG. 11 illustrates a UNPK (i.e. unpacking) instruction according to one embodiment of the invention.

FIG. 12 illustrates an EFLB (i.e. matching) instruction according to one embodiment of the invention.

### DESCRIPTION

Embodiments of the present invention relate to bit-manipulation instructions that perform efficient bit manipulation operations to increase the efficiency of packet processing applications. In one embodiment, a bit manipulation instruction for use in packet processing includes a control. In response to the control, the bit manipulation instruction selects a plurality of bits from a source register and writes the selected plurality of bits into a destination register in a manner designated by the control. In an exemplary environment, the bit manipulation instruction may be implemented by a packet processor core of a packet processor in a network device. In particular, bit manipulation instructions that provide for bit extraction, bit packing, bit setting, bit unpacking and bit matching operation are disclosed.

In the following description, the various embodiments of the present invention will be described in detail. However, such details are included to facilitate understanding of the invention and to describe exemplary embodiments for employing the invention. Such details should not be used to limit the invention to the particular embodiments described because other variations and embodiments are possible while staying within the scope of the invention. Furthermore, although numerous details are set forth in order to provide a thorough understanding of the present invention, it will be apparent to one skilled in the art that these specific details are not required in order to practice the present invention. In other instances details such as, well-known methods, types of data, protocols, procedures, components, networking equipment, electrical structures and circuits, are not described in detail, or are shown in block diagram form, in order not to obscure the present invention. Furthermore, aspects of the invention will be described in particular embodiments but may be implemented in hardware, software, firmware, middleware, or a combination thereof.

In the following description, certain terminology is used to describe various environments in which embodiments of the present invention can be practiced. In general, a “communication system” comprises one or more end nodes having connections to one or more networking devices of a network. More specifically, a “networking device” comprises hardware and/or software used to transfer information through a network. Examples of a networking device include a multi-access service device, a router, a switch, a repeater, or any other device that facilitates the forwarding of information. An “end node” normally comprises a combination of hardware and/or software that constitutes the source or destination of the information. Examples of an end node include a Switch utilized in the Public Switched Telephone Network (PSTN), Local Area Network (LAN), Private Branch Exchange (PBX), telephone, fax machine, video source, computer, printer, workstation, application server, set-top box and the like. “Data traffic” generally comprises one or more signals having one or more bits of data, address, control or any combination thereof transmitted in accordance with any chosen packeting scheme. “Data traffic” can be data, voice, address, and/or control in any representative signaling format or protocol. A “link” is broadly defined as one or more physical or virtual information-carrying mediums that establish a communication pathway such as, for example, optical fiber, electrical wire, cable, bus traces, wireless channels (e.g. radio, satellite frequency, etc.) and the like.

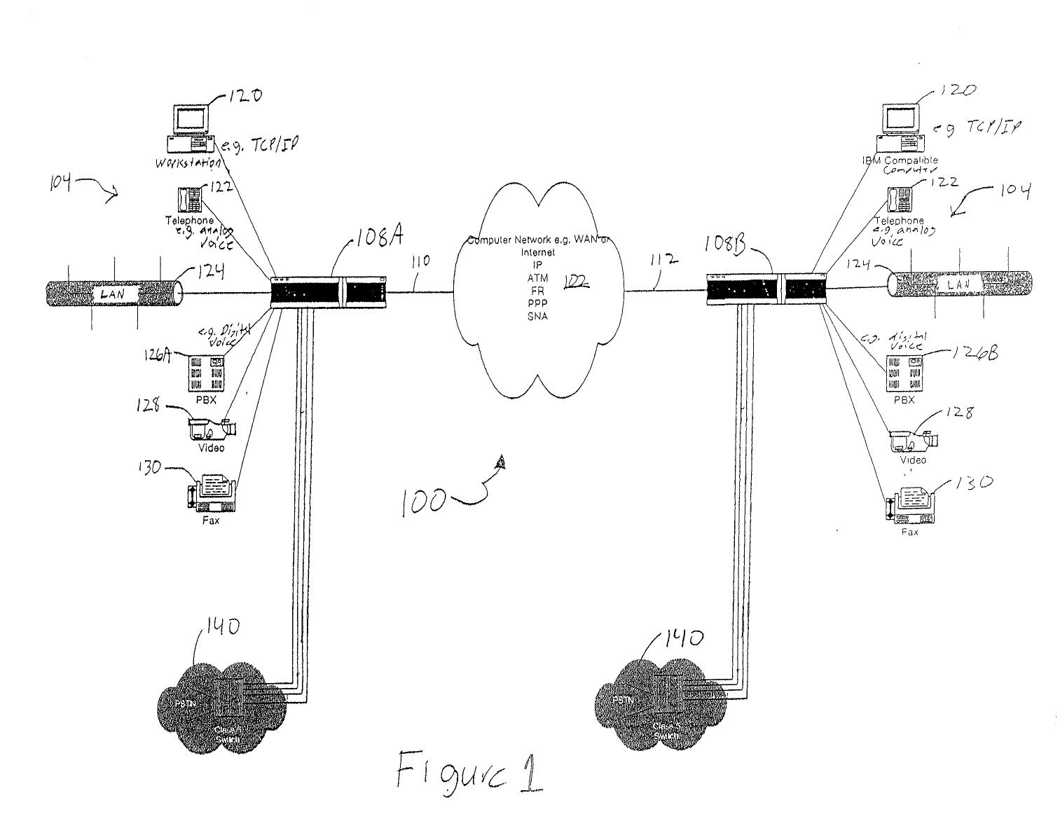

FIG. 1 shows an illustrative example of a voice and data communications system 100. The communication system 100 includes a computer network (e.g. a wide area network (WAN) or the Internet) 102 which is a packetized or a packet-switched network that can utilize Internet Protocol (IP), Asynchronous Transfer Mode (ATM), Frame Relay (FR), Point-to Point Protocol (PPP), Systems Network Architecture (SNA), or any other sort of protocol. The computer network 102 allows the communication of data traffic, e.g. voice/speech data and other types of data, between any end nodes 104 in the communication system 100 using packets. Data traffic through the network may be of any type including voice, graphics, video, audio, e-mail, Fax, text, multi-media, documents and other generic forms of data. The computer network 102 is typically a data network that may contain switching or routing equipment designed to transfer digital data traffic. At each end of the communication system 100 the voice and data traffic requires packetization when transceived across the network 102.

The communication system 100 includes networking devices, such as multi-service access devices 108A and 108B, in order to packetize data traffic for transmission across the computer network 102. A multi-service access device 108 is a device for connecting multiple networks (e.g. a first network to a second network) and devices that use different protocols and also generally includes switching and routing functions. Access devices 108A and 108B are coupled together by network links 110 and 112 to the computer network 102.

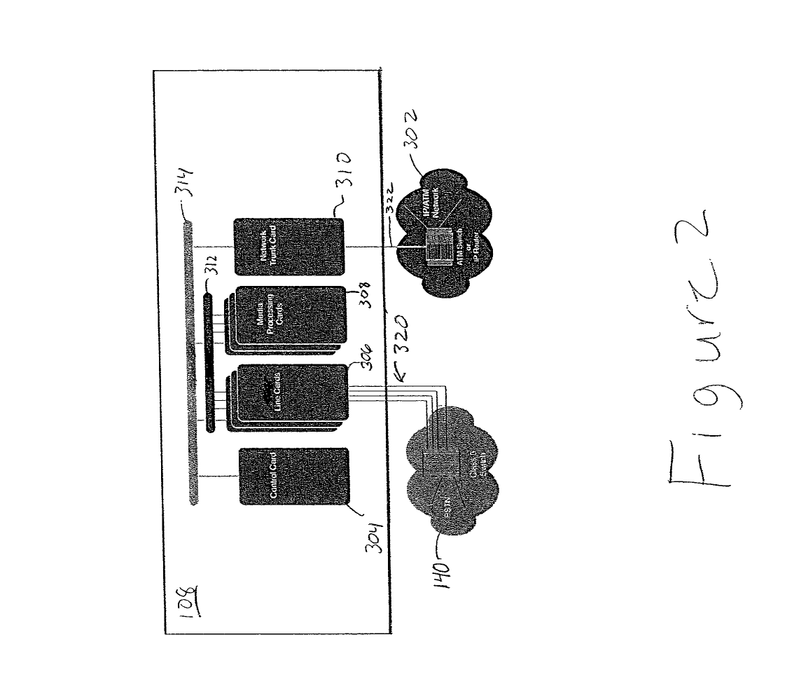

Voice traffic and data traffic may be provided to a multi-service access device 108 from a number of different end nodes 104 in a variety of digital and analog formats. For example, in the exemplary environment shown in FIG. 2, the different end nodes include a class 5 Switch 140 utilized as part of the PSTN, computer/workstation 120, a telephone 122, a LAN 124, a PBX 126, a video source 128, and a fax machine 130 connected via links to the access devices. However, it should be appreciated any number of different types of end nodes can be connected via links to the access devices. In the communication system 100, digital voice, fax, and modem traffic are transceived at PBXs 126A, 126B, and Switch 140, which can be coupled to multiple analog or digital telephones, fax machines, or data modems (not shown). Particularly, the digital voice traffic can be transceived with access devices 108A and 108B, respectively, over the computer packet network 102. Moreover, other data traffic from the other end nodes: computer/workstation 120 (e.g. TCP/IP traffic), LAN 124, and video 128, can be transceived with access devices 108A and 108B, respectively, over the computer packet network 102.

Also, analog voice and fax signals from telephone 122 and fax machine 130 can be transceived with multi-service access devices 108A and 108B, respectively, over the computer packet network 102. The access devices 108 convert the analog voice and fax signals to voice/fax digital data traffic, assemble the voice/fax digital data traffic into packets, and send the packets over the computer packet network 102.

Thus, packetized data traffic in general, and packetized voice traffic in particular, can be transceived with multi-service access devices 108A and 108B, respectively, over the computer packet network 102. Generally, an access device 108 packetizes the information received from a source end node 104 for transmission across the computer packet network 102. Usually, each packet contains the target address, which is used to direct the packet through the computer network to its intended destination end node. Once the packet enters the computer network 102, any number of networking protocols, such as TCP/IP, ATM, FR, PPP, SNA, etc., can be employed to carry the packet to its intended destination end node 104. The packets are generally sent from a source access device to a destination access device over a virtual paths or a connection established between the access devices. The access devices are usually responsible for negotiating and establishing the virtual paths are connections. Data and voice traffic received by the access devices from the computer network are depacketized and decoded for distribution to the appropriate destination end node. It should be appreciated that the FIG. 1 environment is only an exemplary illustration to show how various types of end nodes can be connected to access devices and that embodiments of the present invention can be used with any type of end nodes, network devices, computer networks, and protocols.

FIG. 2 is a simplified block diagram illustrating a conventional multi-service access device 108 in which embodiments of the present invention can be practiced. As shown in FIG. 2, the conventional multi-service access device 108 includes a control card 304, a plurality of line cards 306, a plurality of media processing cards 308, and a network trunk card 310. Continuing with the example of FIG. 1, the switch 140 can be connected to the multi-service access device 108 by connecting cables into the line cards 306, respectively. On the other side, the network trunk card 310 can connect the multi service device 108 to the computer network 102 (e.g. the Internet) through an ATM switch or IP router 302. All of the various cards in this exemplary architecture can be connected through standard buses. As an example, all of the cards 304, 306, 308, and 310, are connected to one another through a Protocol Control Information (PCI) bus 314. The PCI bus 314 connects the network trunk card 310 to the media processing cards 308 and carries the packetized traffic and/or control and supervisory messages from the control card 304. Also, the line cards 306 and the media processing cards 308 are particularly connected to one another through a bus 312. The bus 312 can be a Time Division Multiplexing (TDM) bus (e.g. an H.110 computer telephony bus) that carries the individual timeslots from the line cards 306 to the media processing cards 308.

In this example, the multi-service access device 108 can act as a voice over packet (VoP) gateway to interface a digital TDM switch 140 on the PSTN side to a router or ATM switch 302 on the IP/ATM side. The connection to the TDM switch is typically a group of multiple T1/E1/J1 cable links 320 forming a GR-303 or V5.2 interface whereas the IP/ATM interface typically consists of a Digital Signal Level 3 (DS3) or Optical Carrier Level 3(OC-3) cable link 322 or higher. Thus, in this example, the multi-service access device 108 can perform the functions of providing voice over a computer network, such as the Internet.

Looking particularly at the cards, the control card 304 typically acts as a supervisory element responsible for centralized functions such as configuring the other cards, monitoring system performance, and provisioning. Functions such as signaling gateway or link control may also reside in this card. It is not uncommon for systems to offer redundant control cards given the critical nature of the functions they perform. As to the media processing cards 308, as the name indicates, these cards are responsible for processing media-e.g. voice traffic. This includes tasks such as timeslot switching, voice compression, echo canceling, comfort noise generation, etc. Packetization of the voice traffic may also reside in this card. The network trunk card 310 contains the elements needed to interface to the packet network. The network trunk card 310 maps the network packet (cells) into a layer one physical interface such as DS-3 or OC-3 for transport over the network backbone. As to the line cards 306, these cards form the physical interface to the multiple T1/E1/J1 cable links 320. These cards provide access to the individual voice timeslots and to the “control” channels in a GR-303 or V5.2 interface. The line cards 306 also provide access to the TDM signaling mechanism.

It should be appreciated that this is a simplified example of a multi-service access device 108 used to highlight aspects of embodiments of the present invention for bit-manipulation instructions for packet processing. Furthermore, it should be appreciated that other generally known types of networking devices, multi-service access devices, routers, gateways, switches, wireless base stations etc., that are known in the art, can just as easily be used with embodiments of the present invention for bit-manipulation instructions for packet processing.

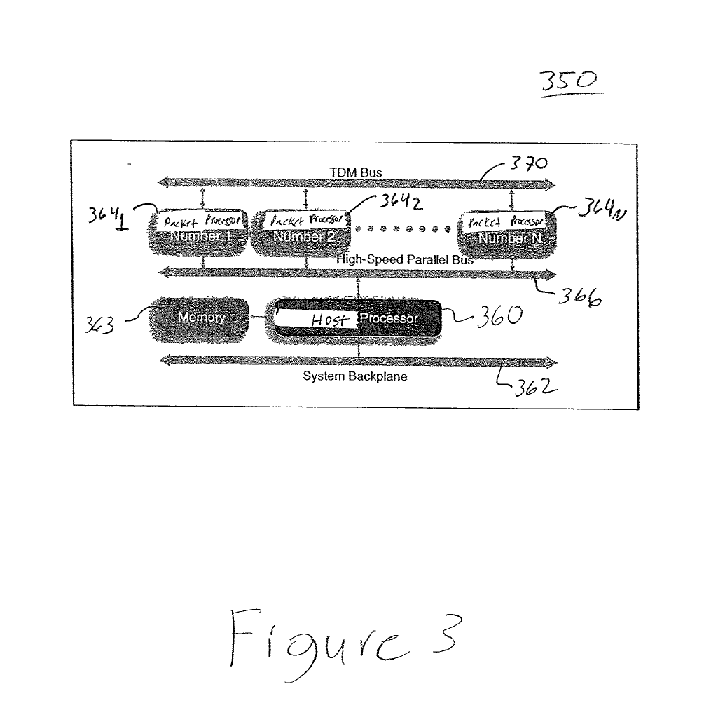

FIG. 3 is a simplified block diagram illustrating an example of a packet processing card 350 in which embodiments of the present invention can be practiced. The packet processing card 350 can be one of the media processing cards 308 or part of one of the media processing cards 308. In one example, the packet processing card 350 can be a voice processing card that performs TDM-to-packet interworking functions that involve Digital Signal Processing (DSP) functions on payload data, followed by packetization, header processing, and aggregation to create a high-speed packet stream.

In the voice processing example, the voice processing functionality can be split into control-plane and data-plane functions, which have different requirements. For example, the control-plane functions include board and device management, command interpretation, call control and signaling conversation, and messaging to call-management servers. The data-plane functions are provided by the bearer channel (which carries all voice and data traffic) which include all TDM-to-packet processing functions: DSP, packet processing, header processing, etc.

FIG. 3 illustrates a packet processing card 350 having a host processor 360 (e.g. an aggregation engine) connected to a system backplane 362, a memory 363, and a high-speed parallel bus 366. The host processor 360 is connected to a plurality of packet processors 364_{1-N} by the high-speed parallel bus 366. The packet processors 364_{1-N} are further connected to a bus 370 (e.g. a TDM bus). The packet processors 364_{1-N}, in one example, can be considered to be DSP devices that generate protocol data unit (PDU) traffic. The packet processing card 350 has a centralized memory 363 for packet buffering and streaming over the packet interface to the switched fabric or packet backplanes. The memory 363 being located in the packet processing card 350 significantly reduces the memory required on the packet processor 364_{1-N} and eliminates the need for external memory for each packet processor, greatly reducing total power consumption enabling robust scalability and packet processing resources.

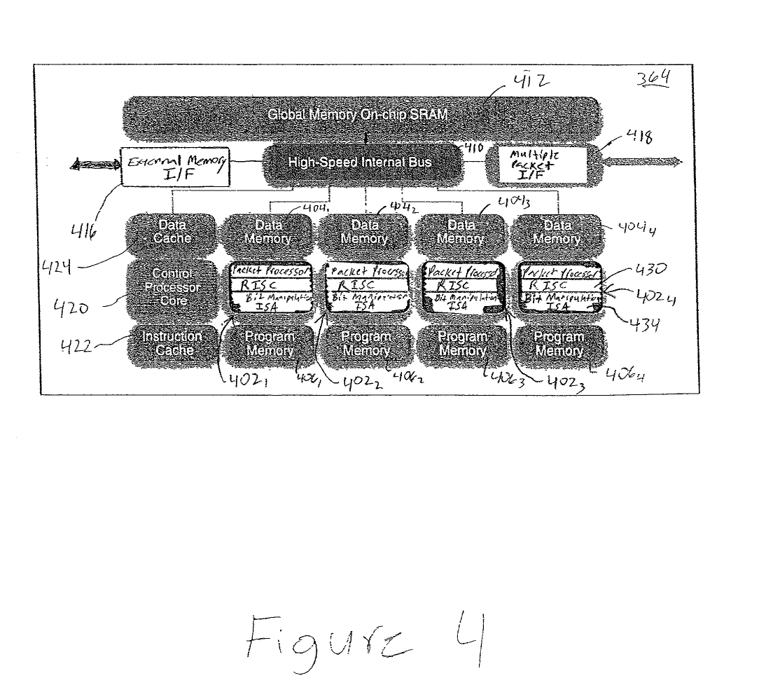

FIG. 4 is a simplified block diagram illustrating an example of a packet processor 364 in which embodiments of the present invention can be practiced. As shown in FIG. 4, the packet processor 364 includes all of the functional blocks necessary to interface with various network devices and buses to enable packet and voice processing subsystems. In this example, the packet processor 364 includes four packet processor cores 402₁₋₄. However, four packet processor cores 402₁₋₄ are only given as an example, and it should be appreciated that any number of packet processor cores can be utilized. The packet processor cores 402₁₋₄ execute algorithms needed to process protocol packets. Moreover, dedicated local data memory 404₁₋₄ and dedicated local program memory 406₁₋₄ are coupled to each packet processor core 402₁₋₄, respectively. A high-speed internal bus 410 and distributed DMA controllers provide the packet processor cores 402₁₋₄ with access to data in a global memory 412. At one end, the packet processor 364 includes an external memory interface port 416 connected to the high-speed internal bus 410 for access to external memory. At the other end, the packet processor 364 includes a multiple packet bus interface 418 connected to the high-speed internal bus 410. For example, the packet bus interface 418 can be a 32-bit parallel host bus interface (VX-Bus) for transferring voice packet data and programming the device. In addition to the VxBus interface, the multiple packet interface 418 may be a standard interface such as a PCI interface or a Utopia Interface.

The packet processor 364 further includes a control processor core 420 (e.g. a RISC based control processor) coupled to an instruction cache 422 and a data cache 424, which are all coupled to the high-speed internal bus 410. The control processor core 420 schedules tasks and manages data flows for the packet processor cores 402₁₋₄ and manages communication with an external host processor. Thus, in addition to the packet processor cores 402₁₋₄, the packet processor 364 includes a RISC based control processor core 420, which manages communication between a system host processor and within the packet processor 364 itself. The control processor core 420 is responsible for scheduling and managing flows of incoming data to one of the packet processor cores 402₁₋₄ and invoking the appropriate program on that packet processing core for processing data. This architecture allows the packet processor cores to concentrate on processing data flows, thus achieving high packet processor core utilization in computational performance. It also eliminates bottlenecks that would occur when the system is scaled upward if all the control processing had to be handled at higher levels in the system.

Furthermore, each packet processor core 402 includes a RISC instruction set architecture (ISA) 430 that is used in conjunction with a bit manipulation ISA 434, according to embodiments of the invention. The bit manipulation ISA 434 can be utilized by the packet processor core 402 to perform effective bit manipulation operations for packet processing applications. Also, the host processor 360 of the packet processing card 350 may also utilize the bit manipulation ISA, according to embodiments of the invention. The bit manipulation ISA 434 will be discussed in detail in the following sections.

However, it should be appreciated that although the example network environment 100 was shown in FIG. 1, the example of a multi-service access device 108 was shown in FIG. 2, the example of a packet processing card 350 was shown in FIG. 3, and the example of a packet processor 364 was shown in FIG. 4, that these are only examples of environments (e.g. packet processing cards, packet processors, and network devices) that the bit manipulation ISA for packet processing according to embodiments of the invention can be used with. Further, it should be appreciated that the bit manipulation ISA for packet processing according to embodiments of the invention can be implemented in a wide variety of packet processing cards, packet processors, and known network devices such as other types of multi-service access devices, routers, switches, wireless base stations, ATM gateways, frame relay access devices, purely computer based networks (e.g. for non-voice digital data), other types of voice gateways and combined voice and data networks, etc., and that the previous described multi-service access device and VoP environment was only given as an example to aid in illustrating one potential environment for the bit manipulation ISA for packet processing according to embodiments of the invention, as will now be discussed.

Further, those skilled in the art will recognize that the exemplary environments illustrated in FIGS. 1-4 are not intended to limit the present invention. Moreover, while aspects of the invention and various functional components have been described in particular embodiments, it should be appreciated these aspects and functionalities can be implemented in hardware, software, firmware, middleware or a combination thereof.

Embodiments of the invention relate to novel and nonobvious bit manipulation instructions that perform efficient bit manipulation operations for packet processing applications. In one embodiment, a bit manipulation instruction for use in packet processing includes a control. In response to the control, the bit manipulation instruction selects a plurality of bits from a source register and writes the selected plurality of bits into a destination register in a manner designated by the control. In an exemplary environment, the bit manipulation instruction may be implemented by a packet processor core of packet processor in a network device. In particular, five bit manipulation instructions for bit extraction, bit packing, bit setting, bit unpacking, and bit matching operations will be disclosed. These instructions are particularly useful for packet processing applications. It should be noted that the instructions to be hereinafter discussed do not perform arithmetic operations on the values being read/written.

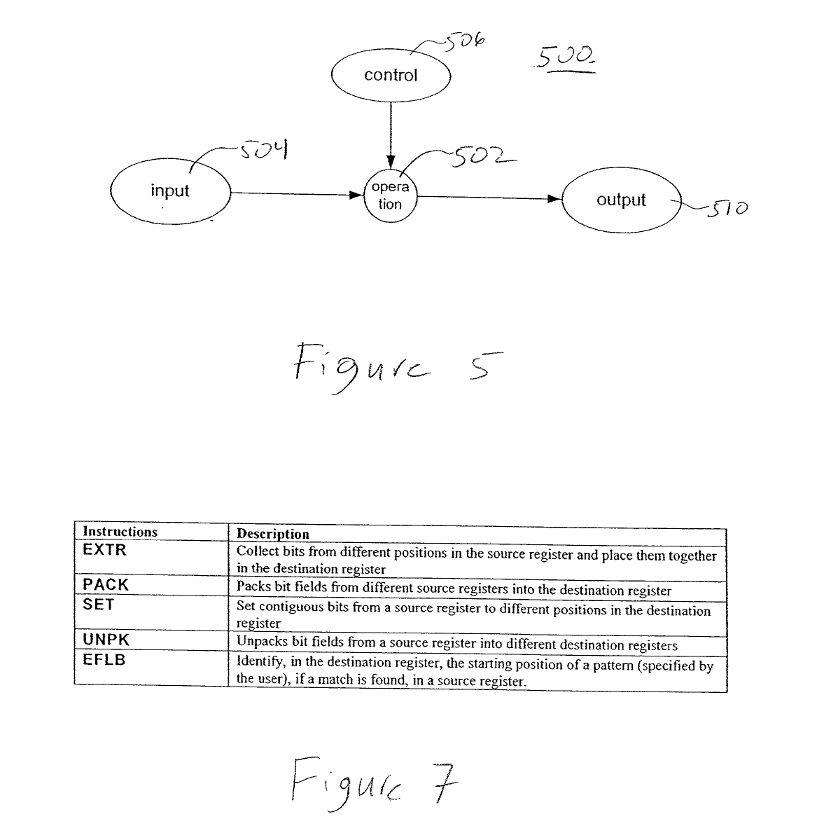

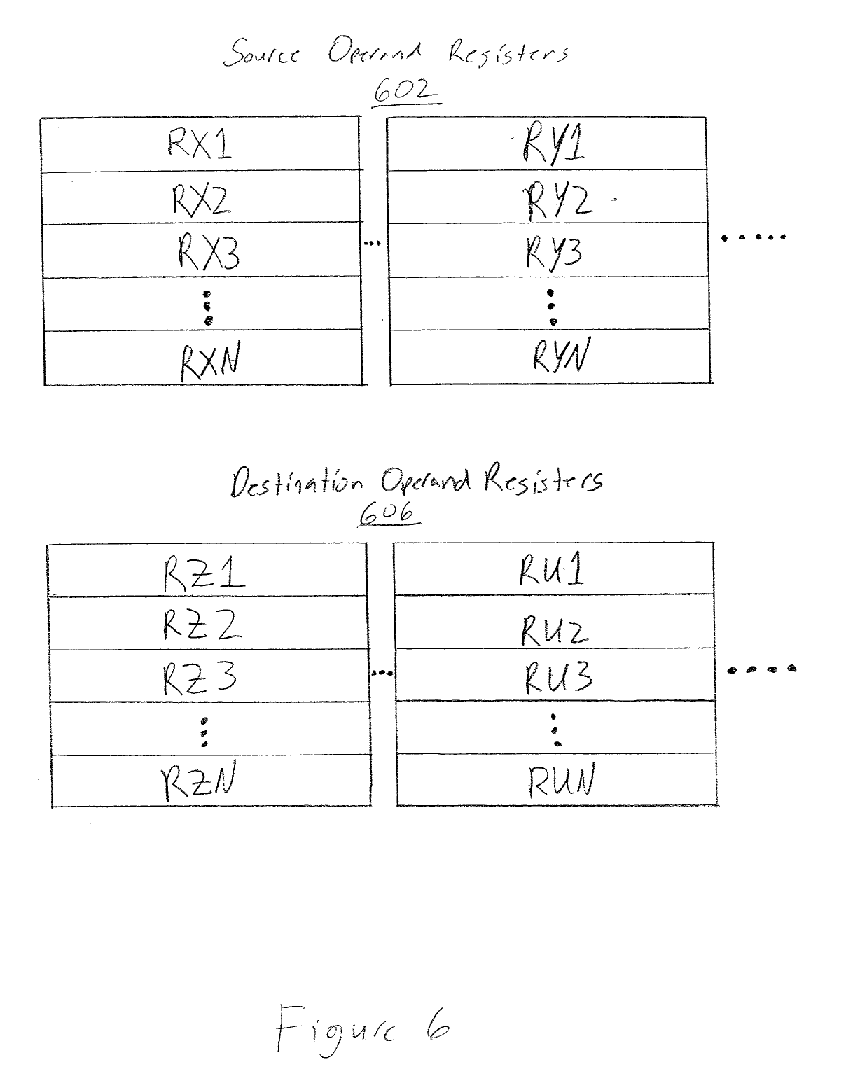

With reference now to FIG. 5, FIG. 5 illustrates a process 500 for implementing a bit-manipulation instruction according to one embodiment of the present invention. Particularly, FIG. 5 shows that during an operation 502 that input data 504 is combined with a control 506 such that output data 510 is yielded. More particularly, with reference also to FIG. 6, FIG. 6 shows a plurality of source operand registers and destination operand registers, which may be utilized in implementing embodiments of the present invention.

In one embodiment, input data 504 such as source operands may be drawn from a plurality of registers. In the present example, source operands may be drawn from upto four registers. For example, with reference also to FIG. 6, source operands may come from source operand data register 602. As will be described in the examplary syntax descriptions that will follow, and as shown in FIG. 6, the source operand data register 602 may store source operands referred to as RX1, RX2, RX3 . . . RXN; RY1, RY2, RY3 . . . RYN; . . . etc. However, it should be appreciated that the source operands may come from different registers. Further, it should be appreciated that this is only an example of a source operand data register.

Continuing with the present example, in one embodiment, output data 504 such as destination operands may be directed at a plurality of registers. In the present example, destination operands may be directed to upto four registers. For example, as shown in FIG. 6, destination operands may be directed to a plurality of destination operand data registers 606. As will be described in the exemplary syntax descriptions that will follow, and as shown in FIG. 6, the destination operand data register 606 may store destination operands referred to as RZ1, RZ2, RZ3 . . . RZN; RU1, RU2, RU3 . . . RUN; . . . etc. It should be appreciated that this is only an example of a destination operand data register.

The control 506 for an instruction is typically embedded in the instruction itself and/or sourced from control registers. For example, when the control 506 is sourced from control registers, the registers with control data are either identified in the instruction or the control data is sourced from standard control registers. Although the need to set up an additional register may appear to be a computational burden, it is likely that the same set of bit manipulation operations is performed on every packet received across all flows. Therefore, the pattern needed can be created once and stored in memory. The pattern can then be downloaded when needed and used on different data values. This avoids the need to re-create the control register dynamically.

In the case where the control is embedded in the instruction itself, it will be specified by optional parameters, in the following detailed discussion of the instructions. Parameters specified in [ ] indicate optional specification. Also, UI refers to unsigned integer and SI refers to signed integer.

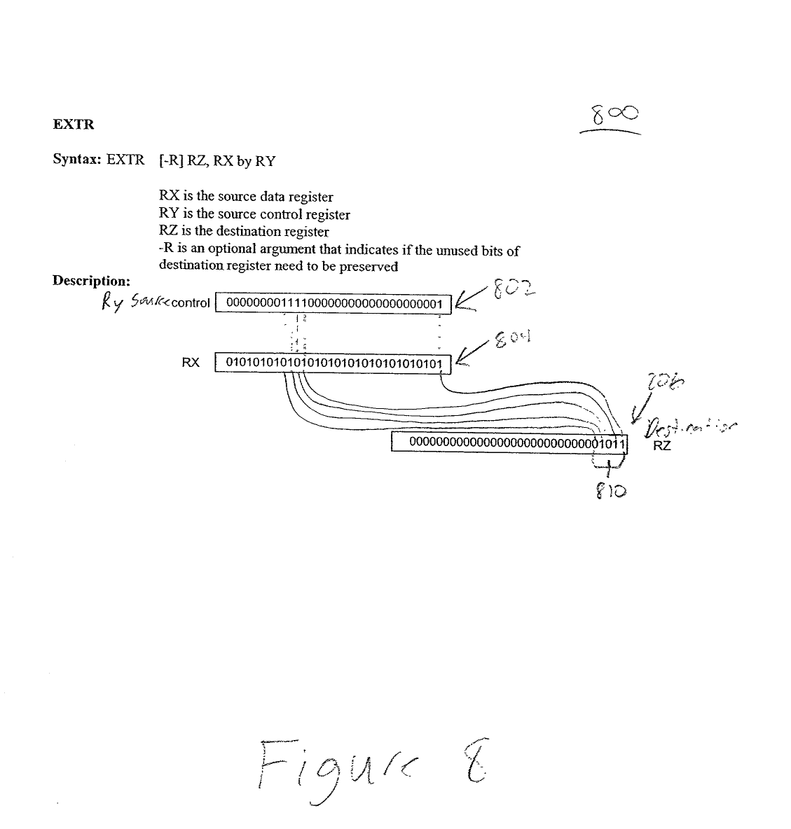

Before the detailed discussion of the bit manipulation instructions is presented a short overview of the instructions will be provided with reference to FIG. 7, FIG. 7 provides a table of the bit manipulation instructions and a short description of each instruction, according to embodiments of the invention. Particularly, as shown in FIG. 7, the EXTR (i.e. extraction) instruction is used to collect bits from different positions in a source register and place them together in a destination register. The PACK (i.e. packing) instruction packs bit fields from different source registers into a destination register. The SET (i.e. setting or shifting) instruction sets contiguous bits from a source register to different positions in a destination register. The UNPK (i.e. unpacking our swapping) instruction unpacks bit fields from a source register into different destination registers. Lastly, the EFLB (i.e. matching) instruction identifies in a destination register whether or not a pattern (i.e. which can be specified in a source control/pattern register by a user) is matched in an input source data register, and if a match is found, the position of the pattern is written into the destination register and a Flag is set to TRUE. Now, moving onto a detailed description of each instruction, the EXTR (i.e. extraction) instruction will be discussed.

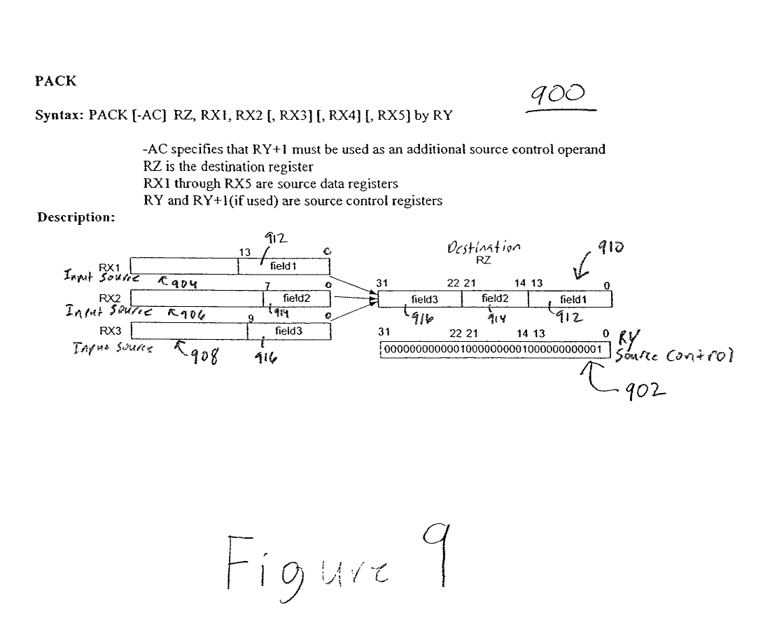

Turning now to FIG. 8, FIG. 8 illustrates an EXTR (i.e. extraction) instruction 800 according to one embodiment of the invention. Basically, the EXTR (i.e. extraction) instruction 800 is used to collect bits from different positions in a source register and place them together in a destination register. As shown in FIG. 8, The EXTR instruction 800 has the following syntax: EXTR [-R] RZ, RX by RY; where:

RX is the source data register;

RY is the source control register;

RZ is the destination register; and

-R is an optional argument that indicates if the original values of unused bits of the destination register need to be preserved.

As shown in FIG. 8, the position of bits to be extracted or gathered is specified through source control register RY 802. Particularly, bits set to “1”in the RY source control register 802 indicate that the corresponding data bits in the RX input source data register 804, at these same positions, are used in the operation of the EXTR (i.e. extraction) instruction. The operation of the EXTR (i.e. extraction) instruction causes the corresponding data bits of the RX input source data register 804 to be extracted in order, from the lowest position to the highest position of the RX input source data register 804, and written into the destination register RZ 806 from the lowest position to highest position in contiguous bits. As shown in FIG. 8, the operation of the EXTR (i.e. extraction) instruction with RX input source data register 804 and RY source control register 802 causes the data bit sequence (01011) 810 to be written into destination register RZ 806.

As another example in hexadecimal, if the RX input source data register=55555555 (hex) and the RY source control register=00F00001(hex) then the operation of the EXTR (i.e. extraction) instruction (Syntax: EXTR RZ, RX by RY) would result in the destination register RZ=0000000B (hex). It should be appreciated that these are only illustrative examples of the EXTR (i.e. extraction) instruction 800.

Moreover, the previously described EXTR (i.e. extraction) instruction allowing for extracting bits from different positions in a source register and placing them together in a destination register is very useful for packet processing applications. In particular, the EXTR instruction executes in one cycle. In comparison, utilizing a traditional RISC instruction set, the number of cycles needed to perform the same bit extraction functionality is around 96 cycles.

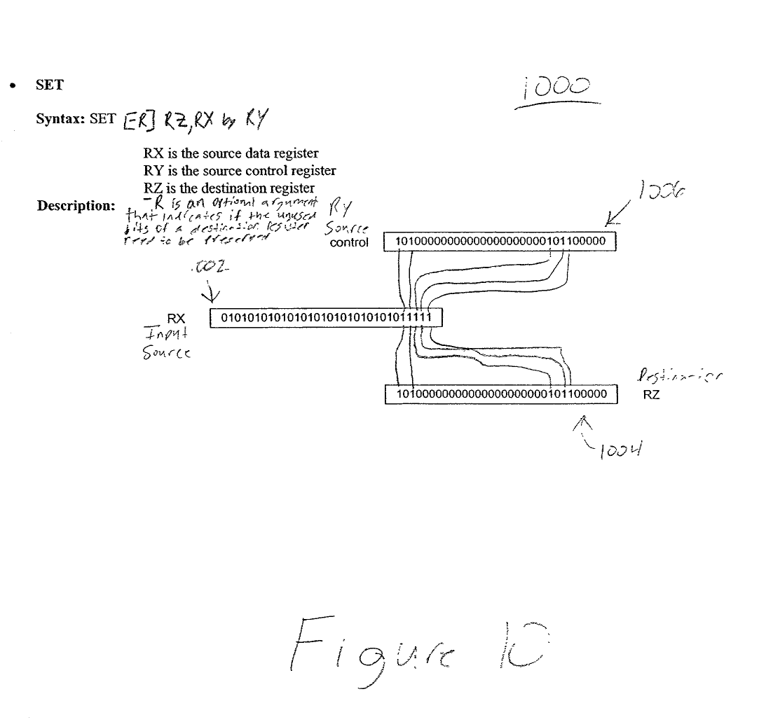

Turning now to FIG. 9, FIG. 9 illustrates a PACK (i.e. packing) instruction 900 according to one embodiment of the invention. Basically, the PACK (i.e. packing) instruction 900 packs bit fields from different source registers into a destination register. As shown in FIG. 9, The PACK instruction 900 has the following syntax: PACK [-AC] RZ, RX1, RX2 [,RX3] [,RX4] [,RX5] by RY; where:

-AC specifies that RY+1 must be used as an additional source control operand;

RZ is the destination register;

RX1 through RX5 are source data registers; and

RY and RY+1 (if used) are source control registers

FIG. 9 illustrates a source control register RY 902. Further, FIG. 9 shows a first input source data register RX1 904, a second input source data register RX2 906, and a third input source data register RX 3 908. Additionally, FIG. 9 illustrates a destination register RZ 910.

Looking again at source control register RY 902, the source control register RY 902 specifies the number of fields to be collected from the input source data registers RX (e.g. RX1 904, RX2 906, and RX3 908) and the length of each field to be collected from each input source data register RX. Particularly, a “1 ” in the source control register RY 902 indicates the start of a new field from a new source register RX (e.g. RX1 904, RX2 906, and RX3 908). The spacing (e.g. the intermediate “0's”) between consecutive “1's” in source control register RY 902 represents the length of the field to be collected. These collected fields are filled into destination register RZ 910 in order starting from the least significant bit position of destination register RZ 910. For the last field only the bits that can fit in the remaining positions of destination register RZ 910 are used. The total number of “1's” in source control register RY 902 indicates the total number of fields from each of the input source data registers RX (e.g. RX1 904, RX2 906, and RX3 908) that are to be collected. This number must equal the number of input source data registers RX (e.g. RX1 904, RX2 906, and RX3 908) that are to be supplied.

FIG. 9 shows an illustrative example of the operation of the PACK (i.e. packing) instruction 900 which packs bit fields from different source registers into a destination register. Partiucularly, source control register RY 902 at the least signficant bit position 0 has a “1” to indicate the the start of a new field from a first source register. Accordingly, the PACK (i.e. packing) instruction 900 implementing source control register RY 902 packs bits from bit positions 0-13, field 1 912, of the first source register RX1 904 and packs the field 1 912 of bits from first source register RX1 912 into destination register RZ 910 at bit positions 0-13. The source control register RY 902 next at bit position 14 has another “1” indicating the the start of a new field from a second source register. Thus, continuing with the present example, the PACK (i.e. packing) instruction 900 implementing source control register RY 902 next packs bits from bit positions 0-7, field 2 914, of second source register RX2 906 and packs the field 2 914 of bits from the second source register RX2 906 into destination register RZ 910 at bit positions 14-21. The source control register RY 902 further at bit position 22 has another “1” indicating the start of a new field from a third source register. Accordingly, continuing with the present example, the PACK (i.e. packing) instruction 900 implementing source control register RY 902 next packs bits from bit positions 0-9, field 3 916 of third source register RX3 908 and packs field 3 916 of bits from the third source register RX3 908 into destination register RZ 910 at bit positions 22-31.

In its most basic form, the PACK instruction 900 supports up to 5 source data operands but can support more if needed. The total number of “1's” in source control registers RY indicates the total number of fields from each of the input source data registers RX (e.g. RX1-RXN) that are to be collected. This number must equal the number input source data registers RX (e.g. RX1-RXN) that are to be supplied.

As another example in hexadecimal, if input source data register RX1=55555555 (hex), input source data register RX2=FFFFFFFF (hex), input source data register RX3=22222222 (hex), input source data register RX4=00000111(hex) and source control register RY=10200801 (hex) then the operation of the the PACK (i.e. packing) instruction 900 (Syntax: PACK RZ, RX1, RX2, RX3, RX4 by RY) will result in destination register RZ=145FFD55 (hex). It should be appreciated that these are only illustrative examples of the PACK (i.e. packing) instruction 900.

The additional control register, RY+1, provides extra functionality to the PACK instruction by controlling which bits are included in the PACK operation. In particular, if the RY+1 register is used for the PACK operation, then for every bit set to 0 in the RY+1 register, the corresponding bit in the RZ register will be set to 0 by the PACK operation, thereby excluding those bits from the PACK operation.

Moreover, the previously described PACK (i.e. packing) instruction allowing for packing bit fields from different source registers into a destination register is very useful for packet processing applications. In particular, the PACK instruction executes in two cycles. In comparison, utilizing a traditional RISC instruction set, the number of cycles needed to perform the same packing functionality is around between 68 to 76 depending on the number of fields used.

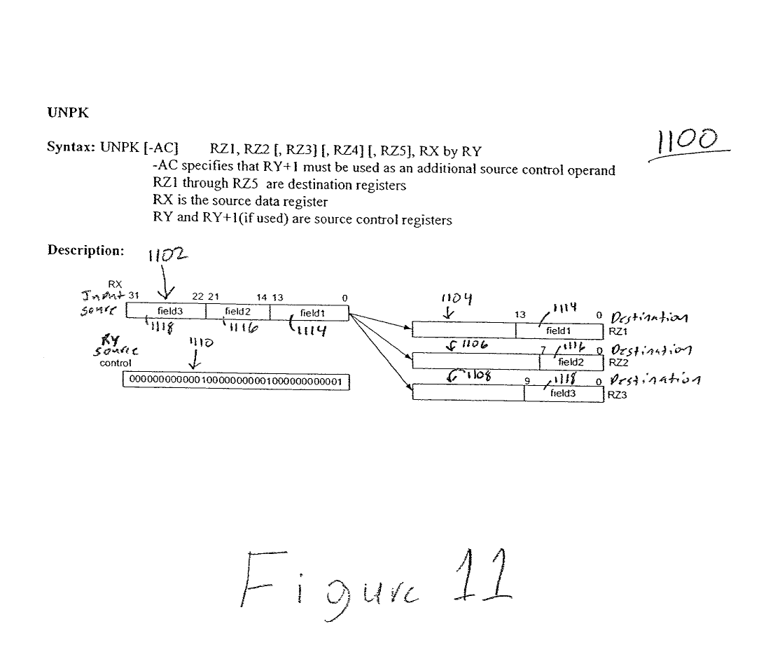

Referring now to FIG. 10, FIG. 10 illustrates a SET (i.e. setting) instruction 1000 according to one embodiment of the invention. Basically, the SET (i.e. setting) instruction 1000 sets contiguous bits from a source register to different positions in a destination register. As shown in FIG. 10, The SET instruction 1000 has the following syntax: SET RZ, RX by RY; where:

RX is the source data register;

RY is the source control register;

RZ is the destination register; and

-R is an optional argument that indicates if the original values of unused bits of the destination register need to be preserved.

As shown in FIG. 10, the SET (i.e. setting) instruction 1000 sets contiguous bits from an RX input source data register 1002 to different positions in a destination register RZ 1004. An RY source control register 1006 specifies which bit positions need to be written into destination register RZ 1004. Particularly, for every bit set to “1” in the RY source control register 1006, a data bit starting from the lowest position in RX input source data register 1002 is read and written into the same position in destination register RZ 1004. The remaining bits in the RX input source data register 1002 are unused and the bit positions that are set to zero in the RY source control register 1006 are set to zero in destination register RZ 1004. Thus, as shown in FIG. 10, the SET (i.e. setting) instruction 1000 shifts contiguous bits (e.g. 11111) from RX input source data register 1002 (from the lowest bit position to highest) and writes them into different positions of the destination register RZ 1004 in a spread out manner in accordance with the bit sequence of RY source control register 1006.

As another example in hexadecimal, if the RX input source data register=5555555F (hex) and the RY source control register=A0000160 (hex) then the operation of the SET (i.e. setting) instruction 1000 (Syntax: SET RZ, RX by RY) would result in the destination register RZ=A0000160 (hex). It should be appreciated that these are only illustrative examples of the SET (i.e. setting) instruction 1000.

Moreover, the previously described SET (i.e. setting) instruction allowing for the setting or shifting of contiguous bits from a source data register to different positions in a destination register is very useful for packet processing applications. In particular, the SET instruction executes in one cycle. In comparison, utilizing a traditional RISC instruction set, the number of cycles needed to perform the same bit setting functionality is around 96 cycles.

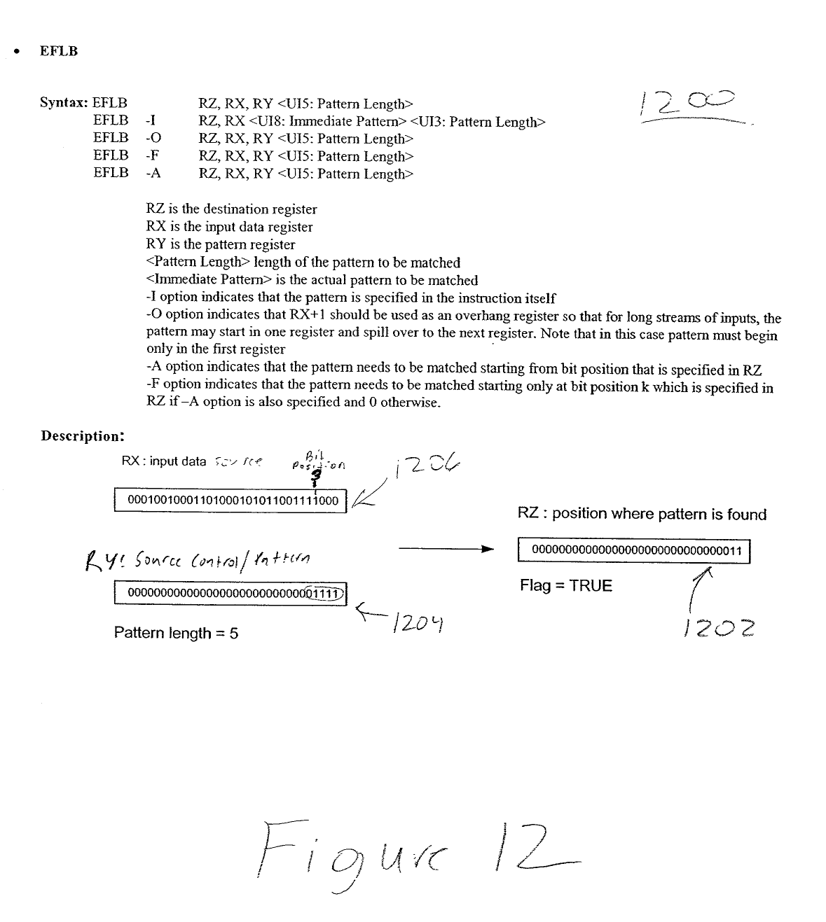

Referring now to FIG. 11, FIG. 11 illustrates a UNPK (i.e. unpacking) instruction 1100 according to one embodiment of the invention. Basically, the UNPK (i.e. unpacking) instruction unpacks bit fields from a source register into different destination registers. As shown in FIG. 11, The UNPK instruction 1100 has the following syntax: UNPK [-AC] RZ1, RZ2 [, RZ3] [, RZ4] [, RZ5], RX by RY; where:

-AC specifies that RY+1 must be used as an additional source control operand;

RZ1 through RZ5 are destination registers;

RX is the source data register; and

RY and RY+1 (if used) are source control registers;

As shown in FIG. 11, the UNPK (i.e. unpacking) instruction 1100 unpacks bit fields from an RX input source data register 1102 into different destination registers-RZ1 1104, RZ2 1106, and RZ3 1108, respectively. An RY source control register 1110 specifies the start of a new field with a bit set to “1” and the new field's length is defined by the number of zeros following the “1” plus 1. A new field (e.g. field 1 1114, field 2 1116, field 3 1118) is created in each one of the destination registers—RZ1 1104, RZ2 1106, and RZ3 1108 starting at the least significant bit, respectively, and each field's length is defined, as previously discussed, by RY source control register 1110. Starting from the least significant bit in RX input source data register 1102 each field (e.g. field 1 1114, field 2 1116, field 3 1118) is copied over to a new destination register RZ. The most significant bits not containing the copied field are filled with 0's in each destination register. Destination registers are filled in the order in which they specified in the instruction.

Further, as shown in this example, the UNPK (i.e. unpacking) instruction 1100 unpacks bit field 1 1114 (occupying bit positions 0-13) of RX input source data register 1102, bit field 2 1116 (occupying bit positions 14-21) of RX input source data register 1102, and bit field 3 1118 (occupying bit positions 22-31) of RX input source data register 1102 into destination register RZ1 1104, destination register RZ2 1106, and destination register RZ3 1108, respectively, in accordance with the UNPK instruction. As shown in FIG. 11, field 1 1114 is unpacked to bit positions 0-13 of destination register RZ1 1104, field 2 1116 is unpacked to bit positions 0-7 of destination register RZ2 1106, and field 3 1118 is unpacked to bit positions 0-9 of destination register RZ3 1108.

In its basic form, the UNPK instruction only supports up to 5 destination registers but can support more if needed The total number of “1's” in source control registers RY indicates the total number of fields in the input source data register RX that are to be unpacked. This number must equal the number output destination data registers RZ (e.g. RZ1-RZN) that are to be updated.

An additional control register RY+1 can be specified to mask certain bits off from the operation. A “O” in RY+1 will prevent the bit in corresponding position in the RX register from being unpacked into a destination register. This has the effect of shrinking a field specified by RY by the number of corresponding bits set to “0” in RY+1 before it is unpacked to its respective RZ.

As another example in hexadecimal, if the RX input source data register=F0F0F0F0 (hex), the RY source control register=40208001 (hex) and the RY+1 source control register=F0FFF0FF (hex) then the operation of the UNPK (i.e. unpacking) instruction 1100 (Syntax: UNPK -AC RZ1, RZ2, RZ3, RZ4, RX by RY) would result in the destination registers RZ being equal to: RZ1=000070F0, RZ2=00000021, RZ3=00000187, and RZ4=00000003, respectively.

Moreover, the previously described the UNPK (i.e. unpacking) instruction allowing for the unpacking of bit fields from a source register into different destination registers is very useful for packet processing applications. In particular, the UNPK instruction executes in two cycles. In comparison, utilizing a traditional RISC instruction set, the number of cycles needed to performing the same unpacking functionality is around 68-76 cycles depenidng on the number of fields used.

Referring now to FIG. 12, FIG. 12 illustrates an EFLB (i.e. matching) instruction 1200 according to one embodiment of the invention. Basically, the EFLB (i.e. matching) instruction 1200 identifies in a destination register whether or not a pattern (e.g. which can be specified in a source control/pattern register by a user) is matched in an input source data register, and if a match is found, the position of the pattern is written into the destination register and a Flag is set to TRUE. As shown in FIG. 12, The EFLB instruction 1200 has the following syntaxes:

EFLB RZ, RX, RY<UI5: Pattern Length>;

EFLB -I RZ, RX<UI8: Immediate Pattern><UI3: Pattern Length>;

EFLB -O RZ, RX, RY<UI5: Pattern Length>;

EFLB -F RZ, RX, RY<UI5: Pattern Length>; and

EFLB -A RZ, RX, RY<UI5: Pattern Length>;

where:

RZ is the destination register;

RX is the input data register;

RY is the pattern register;

<Pattern Length>length of the pattern to be matched;

<Immediate Pattern>is the actual pattern to be matched;

-I option indicates that the pattern is specified in the instruction itself,

-O option indicates that RX+1 should be used as an overhang register so that for long streams of inputs, the pattern may start in one register and spill over to the next register. Note that in this case pattern must begin only in the first register;

-A option indicates that the pattern needs to be matched starting from a bit position that is specified in RZ; and

-F option indicates that the pattern needs to be matched starting only at bit position k which is specified in RZ if -A option is also specified and 0 otherwise.

As shown in FIG. 12, the EFLB (i.e. matching) instruction 1200 identifies in a destination register RZ 1202 whether or not a pattern (e.g. which can be specified in a RY source control/pattern register 1204 by a user) is matched in an input source data register RX 1206, and if a match is found, the position of the pattern is written into the RZ destination register 1202 and a Flag is set to TRUE.

As shown in FIG. 12, input source data register RX 1206 contains the input data. RY source control/pattern register 1204 contains the pattern to be matched. In this example, a pattern length of 5 is specified as part of the instruction. Hence, the pattern that EFLB (i.e. matching) instruction 1200 searches for and tries to match is ‘01111’. In one embodiment, the pattern can be specified by a user. Since the operation of the EFLB (i.e. matching) instruction 1200 finds this pattern starting at bit position 3 in input source data register RX 1206, RZ destination register 1202 will be updated with a value of 3 (e.g. ‘0011’) and a flag will be set to TRUE to indicate that the pattern was found in input source data register RX 1206.

However, it should be appreciated that the pattern itself may optionally be specified in the EFLB (i.e. matching) instruction 1200 itself as an immediate value (e.g. EFLB -I RZ, RX<UI8: Immediate Pattern><UI3: Pattern Length>; where: the -I option indicates that the pattern is specified in the instruction itself). As previously discussed, the user can also specify the position of the input data, where the search should begin. This helps in continuing the search once a pattern is found in a long stream of data. The option of an overhang register is provided to cover the cases where a pattern starts in the input register but not all the bits of the pattern are contained in the input register (e.g. EFLB -O RZ, RX, RY<UI5: Pattern Length>; where: the -O option indicates that RX+1 should be used as an overhang register so that for long streams of inputs, the pattern may start in one register and spill over to the next register . . . note that in this case pattern must begin only in the first register). The EFLB (i.e. matching) instruction 1200 also sets a flag to TRUE or FALSE depending on whether a match is found or not. If the specified pattern is not found in the input data, a value of 32 is written to the destination register RZ.

As another example in hexadecimal, if the RX input source data register=12345678 (hex), the RY source control/pattern register=0000000F (hex) and pattern length is 5, then the operation of EFLB (i.e. matching) instruction 1200 (Syntax: EFLB RZ, RX, RY, 5) would result in the destination registers RZ being equal to: RZ=00000003 (hex).

Thus, the previously described the EFLB (i.e. matching) instruction 1200 identifies in a destination register whether or not a pattern (e.g. which can be specified in a source control/pattern register by a user) is matched in an input source data register, and if a match is found, the position of the pattern is written into the destination register and a Flag is set to TRUE. In particular, the EFLB (i.e. matching) instruction executes in once cycle. In comparison, utilizing a traditional RISC instruction set, the number of cycles needed to perform the same matching functionality is around 3-96 cycles depending on the position where the pattern is found.

The previously described instructions provide significant advantages over tradition RISC instructions in that these novel and non-obvious instructions significantly reduce the number of cycles required to achieve the desired functionality as compared to traditional RISC instructions. Specifically:

1. The previously described SET (i.e. setting) instruction allowing for the setting of contiguous bits from a source data register to different positions in a destination register is very useful for packet processing applications and executes in one cycle. In comparison, utilizing a traditional RISC instruction set, the number of cycles needed to perform the same bit setting functionality is around 96 cycles.

2. The previously described PACK (i.e. packing) instruction allowing for packing bit fields from different source registers into a destination register is very useful for packet processing applications and executes in two cycles. In comparison, utilizing a traditional RISC instruction set, the number of cycles needed to perform the same packing functionality is around between 68 to 76 depending on the number of fields used.

3. The previously described EXTR (i.e. extraction) instruction allowing for extracting bits from different positions in a source register and placing them together in a destination register is very useful for packet processing applications and executes in one cycle. In comparison, utilizing a traditional RISC instruction set, the number of cycles needed to perform the same bit extracting functionality is around 96 cycles.

4. The previously described UNPK (i.e. unpacking) instruction allowing for the unpacking of bit fields from a source register into different destination registers is very useful for packet processing applications and executes in two cycles. In comparison, utilizing a traditional RISC instruction set, the number of cycles needed to performing the same unpacking functionality is around 68-76 cycles depending on the number of fields used.

5. The previously described the EFLB (i.e. matching) instruction identifies in a destination register whether or not a pattern (e.g. which can be specified in a source control/pattern register by a user) is matched in an input source data register, and if a match is found, the position of the pattern is written into the destination register and a Flag is set to TRUE and executes in once cycle. In comparison, utilizing a traditional RISC instruction set, the number of cycles needed to performing the same matching functionality is around 3-96 cycles depending on the position where the pattern is found.

These cycle count reductions directly improve performance for common subtasks in packet processing (e.g. voice packet processing), such as packet classification, flow association and error detection, jitter processing and playout tasks of packet processing resulting in an order of magnitude improvement in processing speed compared to a typical RISC instructions implented by a RISC processor. Thus, the bit manipulation instructions according to embodiments of the invention can be used to help build a high performance packet processors (e.g. voice packet processor) for use in muli-service access devices, switches, routers, or any type of computing device, etc., to therefore support higher densities of packet flows (e.g. voice flows). Use of the bit manipulation instructions according to embodiments of the invention can enable hardware (e.g. packet processors) to be built that require less area and power on an associated board and that can be built at a lower cost.

Those skilled in the art will recognize that although aspects of the invention and various functional components have been described in particular embodiments, it should be appreciated these aspects and functionalities can be implemented in hardware, software, firmware, middleware or a combination thereof.

When implemented in software, firmware, or middleware, the elements of the present invention are the instructions/code segments to perform the necessary tasks. The instructions which when read and executed by a machine or processor, cause the machine processor to perform the operations necessary to implement and/or use embodiments of the invention. As illustrative examples, the “machine” or “processor” may include a digital signal processor, a microcontroller, a state machine, or even a central processing unit having any type of architecture, such as complex instruction set computers (CISC), reduced instruction set computers (RISC), very long instruction work (VLIW), or hybrid architecture. These instructions can be stored in a machine readable medium (e.g. a processor readable medium or a computer program product) or transmitted by a computer data signal embodied in a carrier wave, or a signal modulated by a carrier, over a transmission medium of communication link. The machine-readable medium may include any medium that can store or transfer information in a form readable and executable by a machine. Examples of the machine readable medium include an electronic circuit, a semiconductor memory device, a ROM, a flash memory, an erasable programmable ROM (EPROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via networks such as the Internet, Intranet, etc.

While embodiments of the invention have been described with reference to illustrative embodiments, these descriptions are not intended to be construed in a limiting sense. Various modifications of the illustrative embodiments, as well as other embodiments of the invention, which are apparent to persons skilled in the art to which embodiments of the invention pertain, are deemed to lie within the spirit and scope of the invention.

What is claimed is:

1. An instruction set architecture (ISA) comprising:
a bit manipulation instruction for use in packet processing, the bit manipulation instruction including a control; and
wherein, in response to the control, the bit manipulation instruction to select a plurality of bits from a source register and write the selected plurality of bits into a destination register.

2. The ISA of claim 1, wherein the bit manipulation instruction for packet processing is implemented in a packet processor.

3. The ISA of claim 1, wherein the bit manipulation instruction includes an extraction instruction.

4. The ISA of claim 3, wherein the extraction instruction extracts bits from different positions in the source register and writes the extracted bits in the destination register.

5. The ISA claim 1, wherein the bit manipulation instruction includes a packing instruction.

6. The ISA of claim 5, wherein the packing instruction selects a first field of bits from a first source register and a second field of bits from a second source register and writes the selected first field of bits and the second field of bits in the destination register.

7. The ISA of claim 1, wherein the bit manipulation instruction includes a setting instruction.

8. The ISA of claim 7, wherein the setting instruction selects contiguous bits from the source register and writes the selected contiguous bits into different positions of the destination register.

9. The ISA of claim 1, wherein the bit manipulation instruction includes an unpacking instruction.

10. The ISA of claim 9, wherein the unpacking instruction selects bit fields from a source register and writes the selected bit fields into a plurality of different destination registers.

11. The ISA of claim 1, wherein the bit manipulation instruction includes a matching instruction.

12. The ISA of claim 11, wherein the matching instruction identifies whether a pattern of bits is matched in the source register, and if a match is identified, a position of the pattern of bits is written into the destination register.

13. A packet processor comprising:
a packet processor core to implement an instruction set architecture including a bit manipulation instruction for use in packet processing, the bit manipulation instruction including a control; and
wherein, in response to the control of the bit manipulation instruction, the packet processor core selects a plurality of bits from a source register and writes the selected plurality of bits into a destination register.

14. The packet processor of claim 13, wherein the bit manipulation instruction includes an extraction instruction.

15. The packet processor of claim 14, wherein the extraction instruction instructs the packet processor core to extract bits from different positions in the source register and write the extracted bits in the destination register.

16. The packet processor of claim 13, wherein the bit manipulation instruction includes a packing instruction.

17. The packet processor of claim 16, wherein the packing instruction instructs the packet processor core to select a first field of bits from a first source register and a second field of bits from a second source register and write the selected first field of bits and the selected second field of bits in the destination register.

18. The packet processor of claim 13, wherein the bit manipulation instruction includes a setting instruction.

19. The packet processor of claim 18, wherein the setting instruction instructs the packet processor core to select contiguous bits from the source register and write the selected contiguous bits into different positions of the destination register.

20. The packet processor of claim 13, wherein the bit manipulation instruction includes an unpacking instruction.

21. The packet processor of claim 20, wherein the unpacking instruction instructs the packet processor core to select bit fields from a source register and write the selected bit fields into a plurality of different destination registers.

22. The packet processor of claim 13, wherein the bit manipulation instruction includes a matching instruction.

23. The packet processor of claim 22, wherein the matching instruction instructs the packet processor core to identify whether a pattern of bits is matched in the source register, and if a match is identified, to write a position of the pattern of bits into the destination register.

24. A method comprising:
providing a bit manipulation instruction for packet processing, the bit manipulation instruction including a control, the bit manipulation instruction in response to the control to:
select a plurality of bits from a source register; and
write the selected plurality of bits into a destination register.

25. The method of claim 24, further comprising:
extracting bits from different positions in the source register; and
writing the extracted bits in the destination register.

26. The method of claim 24, further comprising:
selecting a first field of bits from a first source register and a second field of bits from a second source register; and
writing the selected first field of bits and the selected second field of bits in the destination register.

27. The method of claim 24, further comprising:
selecting contiguous bits from the source register; and
writing the selected contiguous bits into different positions of the destination register.

28. The method of claim 24, further comprising:
selecting bit fields from a source register; and
writing the selected bit fields into a plurality of different destination registers.

29. The method of claim 24, further comprising:
identifying whether a pattern of bits is matched in the source register; and
if a match is identified, writing a position of the pattern of bits into the destination registers.

30. A machine-readable medium having stored thereon a bit manipulation instruction including a control for use in packet processing, which when executed by a packet processor, cause the packet processor to perform the following operations:
in response to the control,
selecting a plurality of bits from a source register; and
writing the selected plurality of bits into a destination register.

31. The machine-readable medium of claim 30, wherein the bit manipulation instruction includes an extraction instruction.

32. The machine-readable medium of claim 31, wherein the extraction instruction extracts bits from different positions in the source register and writes the extracted bits in the destination register.

33. The machine-readable medium of claim 30, wherein the bit manipulation instruction includes a packing instruction.

34. The machine-readable medium of claim 32, wherein the packing instruction selects a first field of bits from a first source register and a second field of bits from a second source register and writes the selected first field of bits and the selected second field of bits in the destination register.

35. The machine-readable medium of claim 30, wherein the bit manipulation instruction includes a setting instruction.

36. The machine-readable medium of claim 35, wherein the setting instruction selects contiguous bits from the source register and writes the selected contiguous bits into different positions of the destination register.

37. The machine-readable medium of claim 30, wherein the bit manipulation instruction includes an unpacking instruction.

38. The machine-readable medium of claim 37, wherein the unpacking instruction selects bit fields from a source register and writes the selected bit fields into a plurality of different destination registers.

39. The machine-readable medium of claim 30, wherein the bit manipulation instruction includes a matching instruction.

40. The machine-readable medium of claim 39, wherein the matching instruction identifies whether a pattern of bits is matched in the source register, and if a match is identified, a position of the pattern of bits is written into the destination register.

41. A system comprising:
a network device coupling a first network to a second network, the network device having a packet processor that includes:
a packet processor core to implement an instruction set architecture including a bit manipulation instruction for use in packet processing, the bit manipulation instruction including a control; and
wherein, in response to the control of the bit manipulation instruction, the packet processor core selects a plurality of bits from a source register and writes the selected plurality of bits into a destination register.

42. The system of claim 41, wherein the bit manipulation instruction includes an extraction instruction, the extraction instruction to instruct the packet processor core to extract bits from different positions in the source register and write the extracted bits in the destination register.

43. The system of claim 41, wherein the bit manipulation instruction 2 includes a packing instruction, the packing instruction to instruct the packet processor core to select a first field of bits from a first source register and a second field of bits from a second source register and write the selected first field of bits and the selected second field of bits in the destination register.

44. The system of claim 41, wherein the bit manipulation instruction includes a setting instruction, the setting instruction to instruct the packet processor core to select contiguous bits from the source register and write the selected contiguous bits into different positions of the destination register.

45. The system of claim 41, wherein the bit manipulation instruction includes an unpacking instruction, the unpacking instruction to instruct the packet processor core to select bit fields from a source register and write the selected bit fields into a plurality of different destination registers.

46. The system of claim 41, wherein the bit manipulation instruction includes a matching instruction, the matching instruction to instruct the packet processor core to identify whether a pattern of bits is matched in the source register, and if a match is identified, a position of the pattern of bits is written into the destination register.
